(19) United States
(12) Patent Application Publication
(10) Pub. No.: US 2017/0041324 A1
(43) Pub. Date: Feb. 9, 2017

(54) SYSTEMS AND METHODS FOR PERSONAL PROPERTY INFORMATION MANAGEMENT

(71) Applicant: Pawn Detail, LLC, Tempe, AZ (US)

(72) Inventors: Cipriano Ionutescu, Scottsdale, AZ (US); John Rollie Wightman, Phoenix, AZ (US)

(73) Assignee: Pawn Detail, LLC, Tempe, AZ (US)

(21) Appl. No.: 15/222,717

(22) Filed: Jul. 28, 2016

Related U.S. Application Data
(60) Provisional application No. 62/201,038, filed on Aug. 4, 2015.

(51) Int. Cl. H04L 29/06; G06Q 10/10; G06F 17/30; G06F 21/62; G06F 21/31

(52) U.S. Cl. CPC H04L 63/102; G06F 21/6245; G06F 21/31; G06F 17/30867; G06Q 10/10

(57) ABSTRACT

The present disclosure describes systems and methods of personal property information management. A method of personal property information management may comprise receiving personal property information from a user, associating user information with personal property item information, creating a personal property information record and providing a personal property information report. A method may include providing a personal property information report to a law enforcement database. Systems suitable to perform methods of personal property information management are also provided.

### CROSS-REFERENCE TO RELATED APPLICATIONS

This application is a nonprovisional of, and claims priority to and the benefit of U.S. Provisional Application No. 62/201,038 entitled “SYSTEMS AND METHODS FOR PERSONAL PROPERTY INFORMATION MANAGEMENT” and filed on Aug. 4, 2015, which is hereby incorporated by reference in its entirety.

### FIELD

The present disclosure relates generally to systems and methods for management of information related to personal property.

### BACKGROUND

Traditional systems and methods for creating, populating, managing, and distributing information related to items of personal property require extensive, labor intensive recordkeeping. Thus, systems and methods that reduce effort required to manage personal property database information are desirable.

### SUMMARY

In various embodiments, a method of managing personal property information by a computer based system is provided. A method of managing personal property information can comprise receiving, by a computer based system, an authentication request from a registered user via a user web client. The computer based system may authenticate the registered user and associate the registered user with a registered user account comprising registered user information. The method may further comprise receiving, by the computer based system, personal property information from the user web client. The personal property information may be input by the registered user via the web client. The computer based system may associate the personal property information with the registered user information and create a personal property information record comprising personal property information and registered user information. In various embodiments, the user web client may be a mobile application. The method may include receiving a user assent to a user agreement. The method may further comprise generating a personal property information record identifier and assigning the identifier to the personal property information record. The computer based system may update a database to include personal property information in response to creating a personal property information record, user assent to a user agreement, and/or assigning a personal property information record identifier to the personal property information record. The method may include populating a personal property information report with reportable information comprising information from the personal property information record and providing a personal property information report to a registered user, a retail service provider, a law enforcement agency, or a third party. A personal property information report may be generated and provided automatically or in response to a personal property information report request. Personal property information reports may be provided in a batch comprising a plurality of personal property information reports. A registered user may review a stored personal property information record based on selection of a personal property information record identifier from a list of personal property information record identifiers associated with the registered user.

In various embodiments, a method may comprise registering a new user and further comprise steps of receiving new user information, comparing the new user information with a database of registered user information, creating a new register user in response to comparing the new user information with the database of registered user information, creating a new registered user, prompting the new registered user for new registered user demographic information, and storing the new registered user demographic information in the database of registered users.

In various embodiments, a computer-readable medium is provided having computer-executable instructions for a system for providing personal property information management. Execution of the instructions by a computer based system may cause the computer based system to perform a method comprising authenticating a registered user accessing the system via a user web client, receiving item information from the registered user, creating a personal property information record in response to receiving personal property information, wherein the personal property information record comprises reportable personal property information comprising registered user information and item information, and reporting the personal property information record to at least one of the registered user, a retail service provider, a law enforcement agency, and a third party service provider.

A system for personal property information management may comprise a network interface communicating with a memory, the memory communicating with a processor for providing personal property information management. The processor may perform operations in response to executing a computer program. The operations can comprise associating demographic information regarding an authenticated registered user and personal property information provided by the registered user. The personal property information may be provided via a mobile application. The system may further create a personal property information report comprising reportable personal property information. The system may further provide the personal property information report to one of a personal property information management system provider database and a third party database.

### BRIEF DESCRIPTION OF THE DRAWINGS

A more complete understanding of the present disclosure may be derived by referring to the detailed description and claims when considered in connection with the Figures, wherein like reference numbers refer to similar elements throughout the Figures, and:

FIG. 1 is a block diagram illustrating various system components of a personal property information management system, in accordance with various embodiments;

FIG. 2 illustrates a process flow for managing information related to personal property information based upon information input by a user, in accordance with various embodiments;

FIG. 3 illustrates a process flow for managing new user information and registering a new user, in accordance with various embodiments;

FIG. 4 illustrates a process flow for managing new personal property information provided by a registered user, in accordance with various embodiments;

FIG. 5 illustrates a block diagram of a computer system for personal property information management as well as databases in communication with a computer system for personal property information management, in accordance with various embodiments; and

FIG. 6 illustrates a block diagram of a system architecture for a personal property information management system, in accordance with various embodiments.

### DETAILED DESCRIPTION

The present disclosure generally relates to personal property information management, and more particularly, to systems and methods of personal property information management based on information provided by a user. The detailed description of various embodiments herein makes reference to the accompanying drawings, which show the exemplary embodiments by way of illustration. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, terms such as “transmit,” “communicate” and/or “deliver” may include sending electronic data from one system component to another over a network connection. Additionally, as used herein, “data” may include information such as commands, queries, files, data for storage, and the like in digital or any other form.

As used herein, terms such as “transaction” and “pawn transaction” may include an exchange of personal property information or data in relation to a transaction to be performed without requiring an actual exchange of goods (e.g., a good corresponding to the personal property information involved in the transaction and/or transaction information) or consideration between parties. Moreover, as used herein, the phrase “transaction information” may comprise data associated with one or more transactions. In various embodiments, a transaction may be partially completed using the systems and methods disclosed herein, and the transaction later completed between a user and a merchant with an exchange of goods and/or consideration related to the transaction.

Phrases and terms similar to “account,” “transaction account,” “account number,” “account code,” and/or “consumer account” may include any account that may be used to identify a consumer and/or facilitate a transaction. These accounts may include any device, code (e.g., one or more of an authorization/access code, personal identification number (“PIN”), Internet code, other identification code, and/or the like), number, letter, symbol, digital certificate, digital signal, analog signal, biometric or other identifier/indicia suitably configured to identify a consumer or account owner and/or allow the consumer to access, interact with or communicate with the system.

Phrases and terms similar to “business,” “merchant,” or “retail service provider” may be used interchangeably with each other and shall mean any person, entity, distributor system, software and/or hardware that is a provider, broker and/or any other entity in the distribution chain of goods or services. By way of example, a merchant can include a pawn shop or pawnbroker, a jewelry store, an insurance agency, a personal property information registry service, and the like.

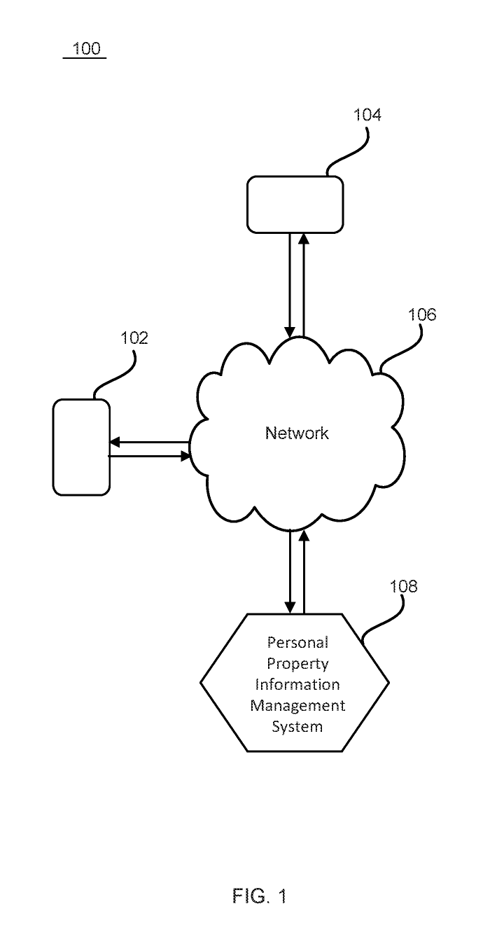

With reference now to FIG. 1, a system 100 for personal property information management is disclosed. In various embodiments, a system 100 may comprise a user web client 102, an administrator web client 104, a network 106, and/or a personal property information management system 108.

A user web client 102 and/or an administrator web client 104 can include any device capable of communicating via any network such as those discussed herein. In various embodiments, a web client may comprise a computer or set of computers, although other types of computing units or systems may be used, including laptops, notebooks, tablets, hand held computers, mobile phones, smart phones, personal digital assistants, set-top boxes, workstations, computer-servers, main frame computers, mini-computers, PC servers, pervasive computers, network sets of computers, personal computers, such as iPads, iMACs, and MacBooks, kiosks, terminals, point of sale (POS) devices and/or terminals, televisions, or any other device capable of receiving data over a network.

A web client 102 and/or 104 may include a browser or browser application. Such a browser or browser applications may comprise Internet browsing software to conduct online transactions and/or communications. A web client 102 and/or 104 may run Microsoft Internet Explorer, Mozilla Firefox, Google Chrome, Apple Safari, or any other of the myriad software packages available for browsing the internet using computers, mobile devices, or other devices.

Practitioners will appreciate that a web client 102 and/or 104 may or may not be in direct contact with an application server. For example, a web client 102 and/or 104 may access the services of an application server through another server and/or hardware component, which may have a direct or indirect connection to an Internet server. For example, a web client 102 and/or 104 may communicate with an application server via a load balancer. In an exemplary embodiment, access is through a network or the Internet through a commercially-available web-browser software package.

As those skilled in the art will appreciate, a web client 102 and/or 104 may include an operating system (e.g., Windows NT, 95/98/2000/CE/Mobile, OS2, OS X, UNIX, Linux, Solaris, MacOS, PalmOS, etc.) as well as various conventional support software and drivers typically associated with computers. A web client 102 and/or 104 can be anywhere there is any type of wired or wireless network connectivity (e.g., in a home or business environment with access to a network). In an exemplary embodiment, access is through a network or the Internet through a commercially available web-browser software package. A web client 102 and/or 104 may implement security protocols such as Secure Sockets Layer (SSL) and Transport Layer Security (TLS). A web client 102 and/or 104 may implement several application layer protocols including http, https, ftp, and sftp.

A personal property information management system 108 may comprise any system associated with a merchant, law enforcement agency, and/or a personal property information management service provider, as described herein. In various embodiments, a personal property information management system 108 is capable of processing information associated with a personal property information record. For example, a personal property information management system 108 may be capable of receiving information associated with a transaction, such as a transaction request, processing the transaction request based upon authentication of a user associated with the transaction request, associating user information with user-provided transaction information, assigning a transaction record identifier to a transaction request, notifying the user of a transaction record identifier, and/or transmitting transaction information (e.g., a transaction record or a transaction report) to the user, the administrator or an agent of the administrator, and/or one or more third parties. To this end, a personal property information management system 108 may comprise a computer-based system, such as, for example, one or more computers or computing units, one or more databases coupled to the one or more computing units, one or more network interfaces, and the like.

Personal property information and/or transaction information may comprise any information associated with a personal property item and/or a transaction or transaction request. For example, transaction information may comprise a transaction amount, a transaction type (such as pawn, buy, cash, or trade), a transaction record identifier (such as a pawn ticket number or other unique identifying information), descriptive or identifying information regarding consideration or security for the transaction (such as identifying information regarding a tangible personal property item or chattel to be sold or pawned), a transaction date, a transaction time, and the like. In accordance with various embodiments, personal property information and/or transaction information comprising identifying information regarding one or more tangible personal property items may comprise a category label, type label, descriptive and identifying information such as brand, model, and/or serial number, physical parameters such as size, weight, color, shape, an image file (such as a digital photograph or video file), and the like.

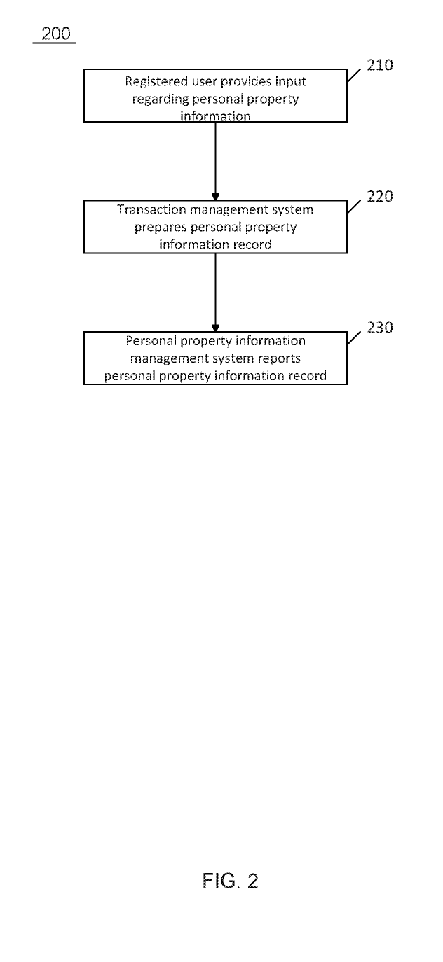

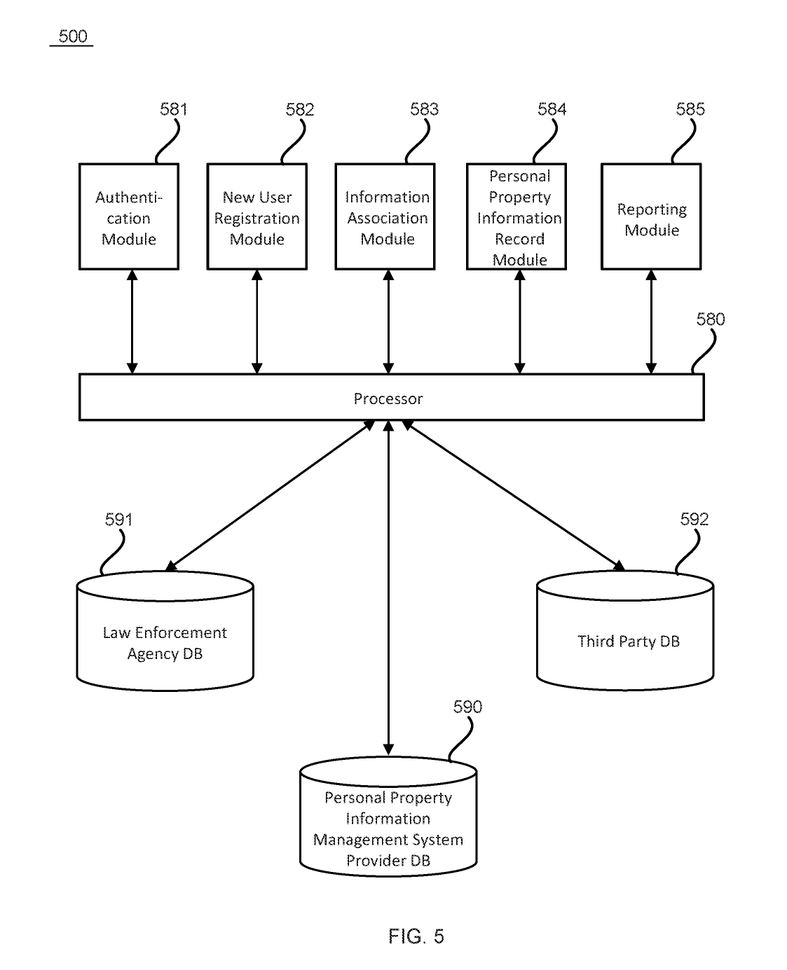

Referring now to FIGS. 2-4, the process flows depicted are merely embodiments and are not intended to limit the scope of the disclosure. For example, the steps recited in any of the method or process descriptions may be executed in any order and are not limited to the order presented. It will be appreciated that the following description makes appropriate references not only to the steps and user interface elements depicted in FIGS. 2-4, but also to the various system components as described above with reference to FIG. 1 and further described below with reference to FIG. 5.

In various embodiments and with reference now to FIG. 1 and FIG. 2, a process 200 for managing information related to personal property based upon user input data or information is shown. A registered user may input personal property information via a user web client 102 (step 210). The user-input personal property information may be transmitted to the personal property information management system 108. In response to user web client 102 providing personal property-related information, the personal property information management system 108 may prepare a personal property information record (step 220). A personal property information record may comprise, for example, registered user demographic information and personal property information, as described in greater detail below. Thus, in various embodiments, a registered user may create a personal property information record as part of process 200. A personal property information record may be stored in a database associated with or in communication with personal property information management system 108. Process 200 may further comprise reporting, by the personal property information management system 108, the personal property information record (step 230). In various embodiments, the personal property information record may be reported to a registered user, a merchant, a personal property information management service provider, a law enforcement agency, or another third party, as described below.

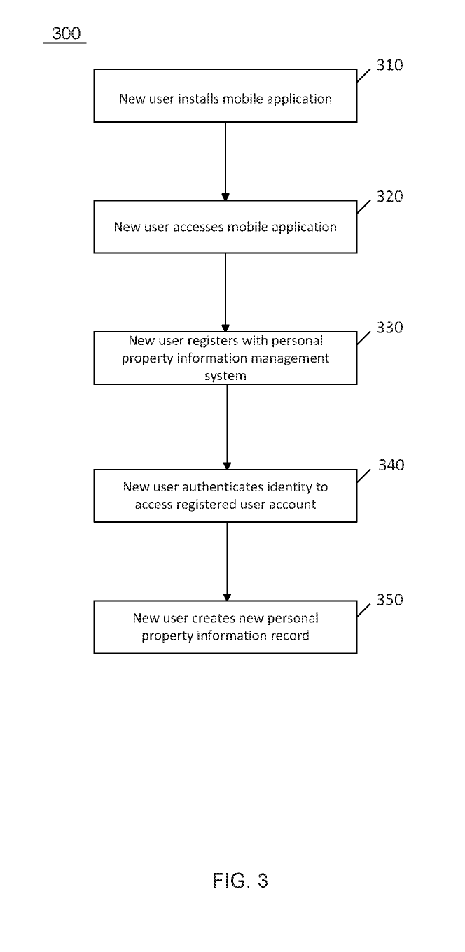

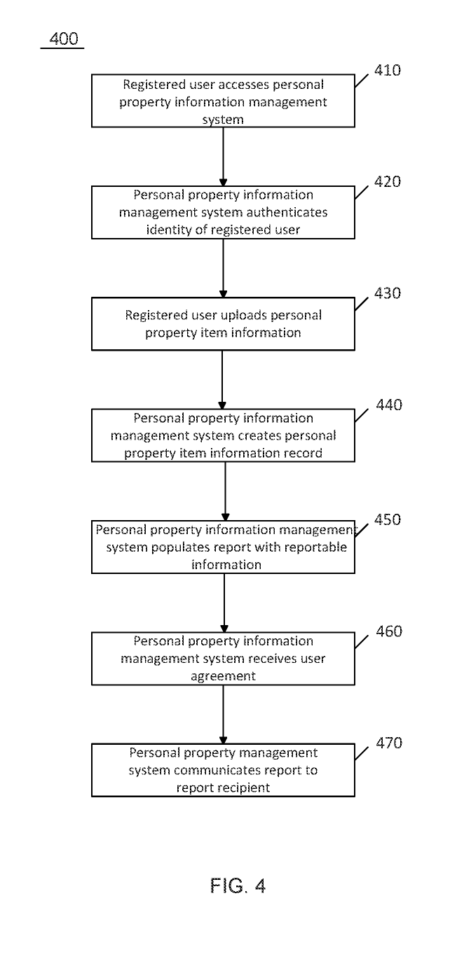

A personal property information management system 108 may further be configured to receive and manage other user information. For example, in various embodiments, personal property information management system 108 may be configured to manage new user registration, access, and/or use of the system. With reference now to FIG. 3, a process 300 for new user registration, access, and personal property information record creation is shown. In various embodiments, a new user may optionally install a mobile application on a user web client 102 (step 310). An example of a mobile application process flow, screen shots, and detailed input and output information are illustrated in Appendix 1, attached hereto and incorporated by reference in its entirety for any purpose. A new user may then access the installed mobile application on the user web client 102 (step 320) to obtain access to the personal property information management system 108 via network 106. The new user may then register with the personal property information management system (step 330) to become a registered user and create a new registered user account in a personal property information management system provider database comprising registered user account information. In various embodiments, a new user may submit a new user registration request via user web client 102. In other embodiments, a new user need not install and access a mobile application to register with the personal property information management system, but instead may access the personal property information management system from a user web client via a browser or other general-purpose application. In various embodiments, following new user registration, a new user may authenticate his identity using account information for the newly created account to access the registered user account (step 340) and create a new personal property information record (step 350), as described in greater detail below with reference to FIG. 4.

Account information may include any information associated with a registered user account and may identify a user account, the account owner, and/or personal property information records associated with a user account. The terms “registered user” and “account owner” may be used interchangeably herein. Account information may include, for example, an account number, account owner information, a security code associated with the account, a user name and/or password associated with the account, user web client 102 identifying information (e.g., a telephone number) and the like. Account owner information may comprise demographic and/or identifying information provided by the account owner, such as name, social security number, driver's license number and state or other identification card information, mailing address or residence address, email address, telephone number, personal information such as gender, date of birth, height, weight, eye color, hair color, race, and/or an image file (such as a photograph or video) of the account owner. In accordance with various embodiments, account owner information may be any information that may be required from a party to a transaction by local laws or regulations in order for that party to enter into certain types of transactions, such as pawn transactions.

Likewise, administrator identifying information may comprise any information capable of identifying an administrator, such as an administrator name, an administrator identifier, an administrator address or location, and the like. Administrator web client 104 identifying information may comprise any information capable of identifying an administrator web client 104, such as an administrator web client 104 identifier. In various embodiments, an administrator may comprise a personal property information management service provider, or an administrator may comprise a merchant.

In various embodiments, a personal property information management system 108 may manage information associated with a personal property information record such as any of the data or information described herein. To illustrate, a personal property information management system 108 may create a personal property information record by associating registered user information with personal property information based upon account and/or transaction information and/or a merchant identifier. For example, and with reference now to FIG. 4, a process 400 of creating and managing a new personal property information record by a registered user is shown. In various embodiments, a user may obtain access to personal property information management system 108 via user web client 102 such as a mobile application or internet browser (step 410). A user may enter certain account information via a user web client 102, such as a user name and password, and this information may be transmitted to the system 108 and used by the system 108 to authenticate the identity of the user to a registered user account of the customer (step 420). In various embodiments, a system may authenticate a user's identity to a registered user account based on a biometric security measure such as a fingerprint scan, a retinal scan, facial recognition, and the like. Similarly, a system may authenticate a user's identity to a registered user account based on a secondary identification measure, such as a driver's license or identification card, swipe, or scan, or number input. A user may enter personal property information via a user web client 102, such as, for example, personal property information regarding an object of a transaction (i.e., an item of tangible personal property) (step 430). This personal property information may be communicated from user web client 102 via network 106 to system 108 and used by the system 108 in relation to management of the personal property information. In various embodiments, personal property information management system 108 may associate various components of account owner information with the personal property information provided by the user (step 440), creating a personal property information record. Personal property information management system 108 may populate a personal property information report with reportable personal property information parsed or extracted from registered user account information and personal property information (step 450). The content and format of a personal property information report may be configured in any suitable format, such as, for example, a reportable transaction information format that may be required for a reportable transaction (such as a pawn transaction) by a law enforcement agency or any predetermined reportable personal property information report format. In various embodiments, reportable personal property information or reportable transaction information may comprise a portion of the information in a personal property information record. Personal property information management system 108 may also receive a user agreement or electronic communication of assent to a user agreement between the user and the personal property information management system provider (step 460). Assent to a user agreement may be communicated in a form of one or more inputs from a user indicating acceptance of a user agreement by a registered user, such as checking a box indicating acceptance of a user agreement (e.g., a first contract input) and/or inputting an electronic signature (e.g., a second contract input).

Personal property information management system 108 may communicate the personal property information report to a report recipient (step 470). In various embodiments, a personal property information report may be communicated in response to a particular event, such as creation of the personal property information report, receipt of user assent to user agreement terms, assignment of a personal property information record identifier, or the like. A personal property information report may be communicated in response to a non-transaction specific and/or recurring event, such as a repeating calendar event (e.g., time of close of business on business days), instructions from a merchant or personal property information management system provider, a record request from a law enforcement agency, or the like. A personal property information report may be communicated to any of a number of report recipients, such as a user, a merchant, a personal property information management system provider, a law enforcement agency, a third party service provider such as a reporting compliance service provider or a financial service provider, and the like. A report format may be customized or configured dependent on the requirements or preferences of a report recipient and/or based on settings created by the personal property information management system provider.

Further, in various embodiments, a personal property information management system 108 may transmit a report to a user web client 102, an administrator web client 104, and/or a third party in response to creating a personal property information record (steps 350/450) or in response to receipt of personal property information. More particularly, a personal property information management system 108 may transmit a report indicating that a transaction request is authorized or declined by the system 108. For example, a personal property information management system 108 may transmit a reply based upon personal property information matching information for personal property reported as stolen. Thus, personal property information management system 108 may transmit a report to a web client or third party in response to receiving personal property information and/or comparing personal property information for a transaction request against information in a database.

In various embodiments, association of account owner information with personal property information by personal property information management system 108 in step 440 may be performed by the system in response to a registered user's entry of personal property information. In various embodiments, system 108 may require a registered user to enter or confirm account owner information, such as various demographic information, along with entry of personal property information and creation of a new personal property information record. Various degrees of automated association of account owner information with personal property information or manual entry of account owner information are possible and within the scope of the present disclosure

In various embodiments, system 108 may provide a registered user accessing the system via user web client 102 access to a list of personal property information records. Personal property information records may be displayed as a menu or selectable list of personal property information record identifiers organized, for example, by personal property information record identifier, item description, or transaction date. A registered user may select a personal property information record to review and/or edit. Editing of various fields, such as personal property information, may be available for various limited periods of time following creation of a personal property information record, such as prior to completion of a transaction or reporting to a third party such as a law enforcement agency. In various embodiments, a registered user may request a personal property information report via user web client 102 for one or more personal property information records. Various other personal property information-related options may be provided by system 108 as well, including transaction related options such as an ability of a registered user to request transaction refinancing or term extension, make a transaction-related payment, or receive a transaction-related payment.

Personal property information management system 108 may provide a merchant or personal property information management system provider with various benefits relating to personal property information management, such as transaction efficiency, overhead, inventory management, regulatory compliance and reporting benefits. For example, increased transaction efficiency may be achieved using personal property information management system 108 by enabling a customer or registered user to input account owner information and personal property information remotely via user web client 102. This increased transaction efficiency may further reduce merchant or system provider overhead by reducing staff time associated with performing steps that may be performed as described above. Similarly, personal property information management system 108 may permit a merchant or personal property information management system provider to assess and monitor current inventory and/or pending inventory (i.e., personal property items for which personal property information has been provided by a registered user, but for which transactions have not yet been approved or completed by a merchant), further facilitating current inventory-based transaction approvals or rejections, searching and advertising of current inventory, or preparation of inventory-based reports. Personal property information management system 108 may provide an enhanced ability to conform with regulatory requirements regarding reporting of reportable transactions, such as by facilitating automated or periodic reporting, for example, by automatically generating reports in response to approval or completion of a transaction or by reporting all approved or completed transactions on a daily basis. Various other features and benefits may be provided, such as automated reporting to users and/or merchants regarding transaction terms coming due or reporting defaulted loans (e.g., for pawn transactions).

Merchants such as pawnbrokers may also benefit from an improved ability to efficiently avoid transactions involving stolen personal property that may be provided by the systems and methods described herein. For example, a merchant may check a serial number included in personal property information associated with a transaction request against a database of personal property information for property reported lost or stolen. Likewise, a personal property information management system may increase sales by enabling a merchant or user to search and identify an item of interested that may be registered by another party in a database of personal property available for sale. Similarly, a merchant may provide an automated custom alert to customers when a good matching a description of an item the customer is interested in becomes available in the merchant's inventory.

Merchants such as insurance agencies may benefit from and offer their insured clients benefits from participation in a personal property information registry system. Creation and maintenance of a personal property information report comprising personal property information records for an insured client's valuable personal property may facilitate insurance claims for lost property and/or reduce fraud. Participation by an insurance agency client might be incentivized by reduced insurance rates. The systems and methods of the present disclosure may also facilitate recovery of lost personal property, for example, via pawnbroker and law enforcement participation. Personal property information records for personal property subject to a loss may also be useful for obtaining replacement bids from merchants.

In various embodiments, the systems and methods of the present disclosure may provide law enforcement agencies with a centralized communication system that may be rapidly and efficiently updated in near-real time. This may facilitate recovery of illegally acquired personal property across jurisdictions in a manner that is challenging or impossible with traditional reporting and database systems. Likewise, the digital photo aspect of the systems and methods of the present disclosure may facilitate application of image recognition software to enhance detection and/or matching of personal property information in a transaction report (such as a pawn transaction report) with that in a loss report, such as may be submitted to a law enforcement agency, an insurance agency, or a third party service. Similarly, law enforcement use of the systems and methods of the present disclosure may enhance law enforcement agency effectiveness in apprehending those engaged in trafficking illegally acquired personal property. Personal property information contained in records as described herein may be used to search various websites that may be used to sell goods, such as eBay.com, craigslist.com, and the like.

The systems and methods of the present disclosure may generally provide for benefits to individual owners of personal property by increasing the ease and efficiency of creating a personal property information record for valuable goods as they are acquired. Likewise, various efficiencies and cost savings related to the various benefits described above may be realized by an individual property owner.

The present system or any part(s) or function(s) thereof may be implemented using hardware, software or a combination thereof and may be implemented in one or more computer systems or other processing systems. However, the manipulations performed by embodiments may be referred to in terms such as matching or selecting, which are commonly associated with mental operations performed by a human operator. No such capability of a human operator is necessary, or desirable in most cases, in any of the operations described herein. Rather, the operations may be machine operations. Useful machines for performing the various embodiments include general purpose digital computers or similar devices.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

In various embodiments, the embodiments are directed toward one or more computer systems capable of carrying out the functionality described herein, such as personal property information management system 500 shown in FIG. 5. In various embodiments, personal property information management system 500 may be any suitable software, hardware and/or hardware—software system configured to process personal property information. In this regarding, personal property information management system may manage information and perform functions described in relation to processes 200, 300, and/or 400 (FIGS. 2-4). Personal property information management system 500 may be operatively coupled to and/or in communication with various web clients and/or databases, as described herein.

Personal property information management system 500 can include one or more processors, such as processor 580. The processor 580 may be connected to a communication infrastructure (e.g., a communications bus, cross-over bar, or network). A communication infrastructure may be operatively connected to a communications interface. A communications interface allows software and data to be transferred between personal property information management system 500 and external devices. Examples of a communications interface may include a modem, a network interface (such as an Ethernet card), a communications port, a Personal Computer Memory Card International Association (PCMCIA) slot and card, etc. Software and data transferred via a communications interface are in the form of signals which may be electronic, electromagnetic, optical or other signals capable of being received by the communications interface. These signals are provided to the communications interface via a communications path (e.g., channel). This channel carries signals and may be implemented using wire or cable, fiber optics, a telephone line, a cellular link, a radio frequency (RF) link and other communications channels. A communication path may facilitate communication of software and data with various web interfaces and/or databases over a network, as described elsewhere herein.

Personal property information management system 500 can include a display interface that forwards graphics, text, and other data from the communication infrastructure (or from a frame buffer not shown) for display on a display unit.

Various software embodiments are described in terms of this exemplary computer system. After reading this description, it will become apparent to a person skilled in the relevant art(s) how to implement various embodiments using other computer systems and/or architectures.

Computer system 500 includes a main memory, such as for example random access memory (RAM), and may also include a secondary memory. The secondary memory may include, for example, a hard disk drive and/or a removable storage drive, such as a floppy disk drive, a magnetic tape drive, an optical disk drive, etc. The removable storage drive reads from and/or writes to a removable storage unit in a well-known manner. As will be appreciated, the removable storage unit can include a tangible computer-readable storage medium having stored therein computer software and/or data.

For purposes of the present disclosure, the terms “computer program medium” and “computer-readable storage medium” are used to generally refer to media such as a removable storage drive or a hard disk installed in a hard disk drive. These computer program products provide software to personal property information management system 500.

Computer programs (also referred to as computer control logic) are stored in main memory and/or secondary memory. Computer programs may also be received via a communications interface. Such computer programs, when executed, enable the personal property information management system 500 to perform the various features as discussed herein. In particular, the computer programs, when executed, enable the processor 580 to perform the features of various embodiments. Accordingly, such computer programs represent controllers of the personal property information management system 500.

In various embodiments, a computer program controlling operation of personal property information management system 500 may comprise various functional modules responsible for directing execution of the operational features of personal property information management system 500. For example, personal property information management system 500 may comprise a registered user authentication module 581. Authentication module 581 may perform step 340 of process 300 (FIG. 3) and/or step 430 of process 400 (FIG. 4).

Likewise, personal property information management system 500 may comprise a new user registration module 582 configured to perform step 330 of process 300. Personal property information management system 500 may also comprise information association module 583 configured to associate registered user demographic information with personal property information, as described in relation to step 440 of process 400.

The system may further comprise personal property information record module 584. Personal property information record module 584 may, for example, create and store a discrete personal property information record in a merchant or personal property information management system provider database, assign a unique personal property information record identifier, or populate a personal property information report with particular registered user or account owner information (e.g., user demographic information) and personal property information. Personal property information record module 584 may, for example, perform step 220 of process 200 (FIG. 2), step 350 of process 300, or step 450 of process 400.

Personal property information management system may further comprise reporting module 585. Reporting module 585 may be configured to prepare and/or communicate personal property information reports or records in accordance with various embodiments. For example, reporting module 585 may report a personal property information record to a registered user, a merchant, a personal property information management system provider, or a third part as described herein. In various embodiments, reporting module 585 may perform step 230 of process 200 or step 470 of process 400. Reporting module 585 may provide one or more reports in response to various events, such as a registered user call, a merchant call, a personal property information management system provider call, a third party call, personal property information record creation, personal property information record identifier assignment by system 500, or a periodically recurring event such as close of business by a merchant. In various embodiments, reporting module 585 may provide a single report or a batch of reports. Reporting module 585 of system 500 may provide reports in any of a variety of forms, such as formatting personal property information for display on a display interface or a web interface, emailing a report, or uploading a report to a database. Reporting module 585 may provide reports by directing processor 580 to format and transfer personal property information or a personal property information report via communication infrastructure and a communication interface of system 500 to web interfaces or databases over a network.

Other functional modules are possible and may further comprise elements of system 500, such as a new user registration module, a payment processing module, an inventory management module, user web client communication module, administrator web client communication module, and the like.

One skilled in the art will appreciate that system 500 may employ or communicate with any number of databases in any number of configurations. For example and as shown in FIG. 5, system 500 may communicate with databases such as personal property information management system provider database 590. In various embodiments, personal property information management system provider database 590 may be a feature of system 500 and comprise a database for storage of registered user information and personal property information. Data stored in a database such as personal property information management system provider database 590 may be organized according to any of a number of criteria. For example, data stored in a personal property information management system used for transaction management may be organized by user or account owner, seller or merchant, transaction type (e.g., pawn, buy, cash, or trade), category of good and/or other item-related information, location and/or relevant law enforcement agency for reporting purposes, transaction date and/or transaction status (e.g., pending, completed, refinanced, defaulted, etc.), and the like.

In various embodiments, system 500 may also communicate with a law enforcement agency database 591. System 500 may provide transaction reports to one or more law enforcement agency databases 591 in any suitable format and with any suitable timing for purposes of compliance with reporting requirements that may be applicable to various types of transactions, such as pawn transactions. Reporting module 585 of system 500 may be configured to direct processor 580 to provide transaction reports or other personal property information record data to a law enforcement agency database 591 in any manner that may be required by the law enforcement agency and/or local laws and regulations that may govern such reporting.

System 500 may also communicate with one or more third party databases 592. For example, if a personal property information management system provider is a service provider providing transaction management services to multiple merchants, third party databases 592 may comprise individual merchant databases. A third party database 592 may also comprise a financial service or payment management service database and/or related service, such as, for example, a database and/or service provided by authorize.net®.

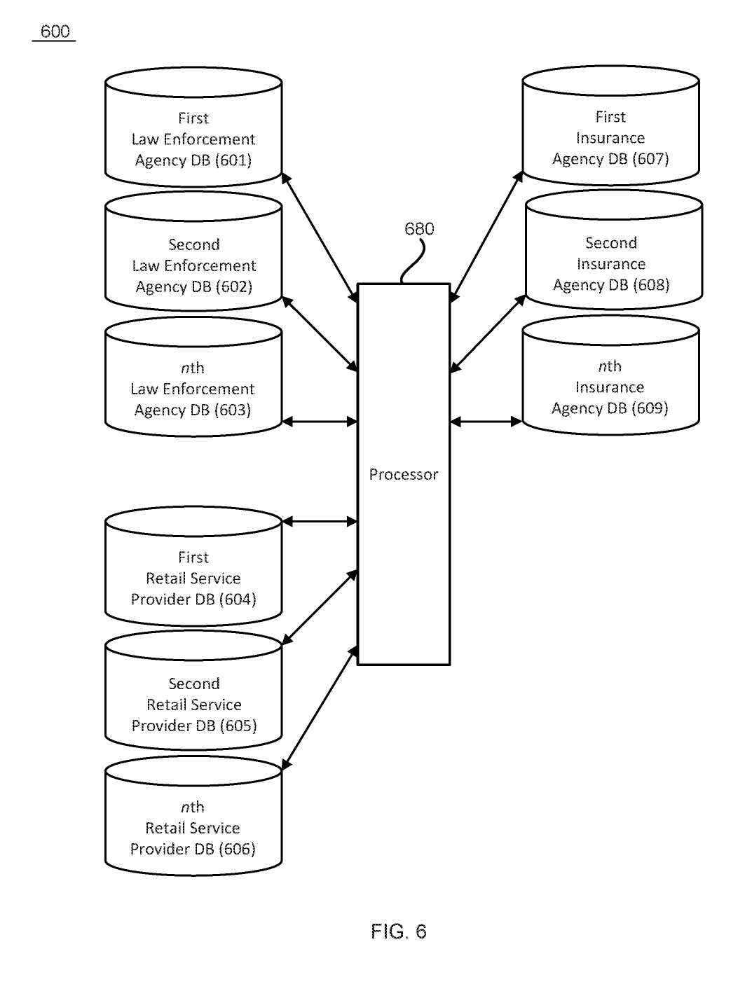

With reference now to FIG. 6, a system architecture of a personal property information management system 600 in accordance with various embodiments is illustrated. Personal property information management system 600 may comprise various components described above with reference to system 500. As mentioned briefly above and described in more detail below with reference to system 600 illustrated in FIG. 6, a personal property information management system 600 may be operatively coupled to and/or in communication with various web clients and/or databases. Personal property information management system 600 can include one or more processors, such as processor 680. The processor 680 is connected to a communication infrastructure that may be configured to operably connect processor 680 with a plurality of web clients and/or databases.

Web clients and/or databases that may be operatively coupled to system 600 can include a plurality of law enforcement agency databases, a plurality of retail service provider (e.g., pawnbrokers) databases, a plurality of insurance agency databases, and/or a plurality of other third party service provider databases. For example, system 600 may be in communication with a first law enforcement agency database 601 for a first law enforcement agency in a first jurisdiction, a second law enforcement agency database 602 for a second law enforcement agency in a second jurisdiction, and an nth law enforcement agency database 603 for an nth law enforcement agency in an nth jurisdiction. Law enforcement agency databases can comprise databases for agencies in a plurality of jurisdictions, for example, different municipalities, counties, cities, states, or countries. Similarly, a law enforcement agency can comprise different enforcement agencies, such as the U.S. Federal Bureau of Investigations, the U.S. Immigration and Customs Enforcement agency, the U.S. Marshals Service, and the like.

Similarly, system 600 can comprise a plurality of pawn shop and/or other retail service provider databases operatively coupled to system 600. For example, system 600 may be in communication with a first retail service provider database 604 for a first retail service provider, a second retail service provider database 605 for a second retail service provider, and an nth retail service provider database 606 for an nth retail service provider. Likewise, system 600 can comprise a plurality of insurance agency databases operatively coupled to system 600. For example, system 600 may be in communication with a first insurance agency database 607 for a first insurance agency, a second insurance agency database 608 for a second insurance agency, and an nth retail insurance agency database 609 for an nth insurance agency.

Any database described herein may be any type of database having any configuration, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of system 2100, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with system 500 by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments of system 500, the data can be stored without regard to a common format. However, in one exemplary embodiment, the data set (e.g., BLOB) may be annotated in a standard manner when provided for manipulating the data onto the financial transaction instrument. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a stand-alone interaction device configured to add, delete, modify, or augment the data in accordance with the header or trailer. As such, in various embodiments, the header or trailer is not stored on the transaction device along with the associated issuer-owned data but instead the appropriate action may be taken by providing to the transaction instrument user at the stand-alone device, the appropriate option for the action to be taken. System 500 contemplates a data storage arrangement wherein the header or trailer, or header or trailer history, of the data is stored on the transaction instrument in relation to the appropriate data.

One skilled in the art will also appreciate that, for security reasons, any databases, systems, devices, servers or other components of system 500 may consist of any combination thereof at a single location or at multiple locations, wherein each database or system 500 includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PKI, GPG (GnuPG), and symmetric and asymmetric cryptosystems.

A firewall may include any hardware and/or software suitably configured to protect CMS components and/or enterprise computing resources from users of other networks. Further, a firewall may be configured to limit or restrict access to various systems and components behind the firewall for web clients connecting through a web server. A firewall may reside in varying configurations including Stateful Inspection, Proxy based, access control lists, and Packet Filtering among others. A firewall may be integrated within a web server or any other CMS components or may further reside as a separate entity. A firewall may implement network address translation (“NAT”) and/or network address port translation (“NAPT”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

In addition to those described above, the various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; law enforcement data; and/or like data useful in the operation of the present system. As those skilled in the art will appreciate, user computer may include an operating system (e.g., Windows NT, 95/98/2000, OS2, OS X, UNIX, Linux, Solaris, MacOS, etc.) as well as various conventional support software and drivers typically associated with computers. The computer may include any suitable personal computer, network computer, workstation, minicomputer, mainframe or the like. A user web interface can be in a home or business environment with access to a network. In an exemplary embodiment, access to system 500 is through a network or the Internet through a commercially-available web-browser software package.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical web site might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL (http://yahoo.com/stockquotes/ge) and an IP address (123.56.789.234). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. See, e.g., Alex Nghiem, IT Web Services: A Roadmap for the Enterprise (2003), hereby incorporated by reference.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. Web Sphere MQ™ (formerly MQSeries) by IBM, Inc. (Armonk, N.Y.) is an example of a commercially available middleware product. An Enterprise Service Bus (“ESB”) application is another example of middleware.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system may be implemented with TCP/IP communications protocols, the system may also be implemented using IPX, Appletalk, IP-6, NetBIOS, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAvA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing at http://csrc.nist.gov/publications/nistpubs/800-145/SP800-145.pdf (last visited Mar. 18, 2015), which is hereby incorporated by reference in its entirety.

In various embodiments, components, modules, and/or engines of a system as described herein may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app. In various embodiments, a micro-app may be made available as a service.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

The disclosure may be described herein in terms of functional block components, screen shots, optional selections and various processing steps. It should be appreciated that such functional blocks may be realized by any number of hardware and/or software components configured to perform the specified functions. It should be appreciated that such functional blocks may be realized by any number of computer-based systems and tangible non-transitory computer readable storage medium configured to perform the specified functions. For example, system 500 may employ various integrated circuit components, e.g., memory elements, processing elements, logic elements, look-up tables, and/or the like, which may carry out a variety of functions under the control of one or more microprocessors or other control devices. Similarly, the software elements of system 500 may be implemented with any programming or scripting language such as C, C++, Java, COBOL, assembler, PERL, Visual Basic, SQL Stored Procedures, extensible markup language (XML), with the various algorithms being implemented with any combination of data structures, objects, processes, routines or other programming elements. Further, it should be noted that system 500 may employ any number of conventional techniques for data transmission, signaling, data processing, network control, and/or the like. Still further, system 500 could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

These software elements may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, may be implemented by either special purpose hardware-based computer systems which perform the specified functions or steps, or suitable combinations of special purpose hardware and computer instructions. Practitioners will appreciate that the illustrated steps described herein may comprise in any number of configurations including the use of windows, web pages, web forms, popup windows, prompts and/or the like. It should be further appreciated that the multiple steps as illustrated and described may be combined into single web pages and/or windows but have been expanded for the sake of simplicity. In other cases, steps illustrated and described as single process steps may be separated into multiple web pages and/or windows but have been combined for simplicity.

Practitioners will appreciate that there are a number of methods for displaying data within a browser-based document. Data may be represented as standard text or within a fixed list, scrollable list, drop-down list, editable text field, fixed text field, pop-up window, and/or the like. Likewise, there are a number of methods available for modifying data in a web page such as, for example, free text entry using a keyboard, selection of menu items, check boxes, option boxes, and/or the like.

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, or C’ is used in the claims or specification, it is intended that the phrase be interpreted to mean that A alone may be present in various embodiments, B alone may be present in various embodiments, C alone may be present in various embodiments, or that any combination of the elements A, B and C may be present in a single embodiment; for example, A and B, A and C, B and C, or A and B and C. All structural and functional equivalents to the elements of the above-described exemplary embodiments that are known to those of ordinary skill in the art are expressly incorporated herein by reference and are intended to be encompassed by the present claims. Further, a list of elements does not include only those elements but may include other elements not expressly listed or inherent to such process, method, article, or apparatus. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A method comprising:
receiving, by a computer based system for personal property information management, an authentication request from a first registered user via a user web client;
authenticating, by the computer based system, the first registered user in response to receiving the authentication request, wherein the authenticating associates the first registered user with a first registered user account comprising first registered user information;
receiving, by the computer based system, first personal property information from the user web client, wherein the first personal property information comprises identifying information regarding a first personal property item;
associating, by the computer based system, the first personal property information with the first registered user information; and
creating, by the computer based system, a first personal property information record comprising the first personal property information and the first registered user information.

2. The method of claim 1, wherein the user web client is a mobile application.

3. The method of claim 1, wherein the authentication request comprises first registered user web client identification information.

4. The method of claim 1, wherein the first personal property information comprises one of an image file and a video file.

5. The method of claim 1, further comprising displaying, on the user web client, a first transaction user agreement for a first transaction.

6. The method of claim 1, further comprising receiving, by the computer based system, a first contract input comprising first registered user acceptance of the first transaction user agreement.

7. The method of claim 1, further comprising receiving, by the computer based system, a second contract input comprising first registered user execution of the first transaction user agreement.

8. The method of claim 1, further comprising generating, by the computer based system, a first transaction record identifier.

9. The method of claim 8, further comprising assigning, by the computer based system, the first transaction record identifier to the first personal property information record.

10. The method of claim 9, further comprising updating, by the computer based system, a database to include first transaction information in response one of creating the first personal property information record, receiving the first contract input, receiving the second contract input, and assigning the first transaction record identifier to the first personal property information record.

11. The method of claim 10, further comprising populating, by the computer based system, a first transaction report with reportable transaction information, wherein the reportable transaction information comprises a portion of the first personal property information record.

12. The method of claim 11, wherein the first transaction report comprises reportable transaction information in a predetermined reportable transaction information format.

13. The method of claim 12, further comprising providing, by the computer based system and in response to updating the database, the first transaction report to one of the first registered user, a retail service provider, a law enforcement agency, and a third party service provider.

14. The method of claim 12, further comprising providing, by the computer based system and in response to an action by an administrator agent via an administrator web client, the first transaction report to one of the first registered user, a retail service provider, a law enforcement agency, and a third party service provider.

15. The method of claim 14, further comprising providing a plurality of transaction reports.

16. The method of claim 10, further comprising displaying a menu comprising a list of stored transaction record identifiers associated with the first registered user, wherein each transaction record identifier in the list of stored transaction record identifiers may be selected by the first registered user via the user web client.

17. The method of claim 16, further comprising displaying, in response to selecting a first stored transaction record identifier from the menu, a first stored transaction record associated with the first stored transaction record identifier.

18. The method of claim 2, further comprising:
registering, by the computer based system, a new user in response to receiving a new user registration request via the mobile application, registering comprising steps of:
receiving, by the computer based system, new user information provided by the new user via the mobile application;
comparing, by the computer based system, the new user information with a database of registered user information;
creating, by the computer based system, a new registered user in response to comparing the new user information with the database of registered user information;
prompting the new registered user for new registered user demographic information via the mobile application;
storing, by the computer based system, the new registered user demographic information in a database of registered users.

19. A tangible computer-readable storage medium having computer-executable instructions stored thereon that, if executed by a computer based system for providing personal property information management, causes the computer based system to perform a method comprising:
authenticating, by the computer based system, a registered user accessing the computer based system via a user web client;
receiving, by the computer based system and via the user web client, first item information from the registered user;
creating, by the computer based system, a first transaction record in response to receiving first item information, wherein first transaction record comprises reportable transaction information comprising registered user information and first item information; and
reporting, by the computer based system, the first transaction record to at least one of the registered user, a retail service provider, a law enforcement agency, and a third party service provider.

20. A system comprising:
a network interface communicating with a memory;
the memory communicating with a processor for providing personal property information management; and
the processor, when executing a computer program, performs operations comprising:
associating, by the processor, demographic information regarding an authenticated registered user and personal property information provided by the registered user via a mobile application;
creating, by the processor, a transaction report comprising reportable transaction information; and
providing, via a network connection, the transaction report to one of a transaction system provider database and a third party database.
